(19) United States
(12) Patent Application Publication
(10) Pub. No.: US 2022/0224153 A1
(43) Pub. Date: Jul. 14, 2022

(54) WIRELESS CHARGING SYSTEM FOR SMART GARMENTS SUPPORTING MULTIPLE CHARGING METHODS

(71) Applicants: Analog Devices, Inc., Wilmington, MA (US); UNIVERSITY OF FLORIDA RESEARCH FOUNDATION, INC., Gainesville, FL (US)

(72) Inventors: Patrick RIEHL, Lynnfield, MA (US); Chin-Wei CHANG, Gainesville, FL (US); Jenshan LIN, Gainesville, FL (US)

(73) Assignees: Analog Devices, Inc., Wilmington, MA (US); UNIVERSITY OF FLORIDA RESEARCH FOUNDATION, INC., Gainesville, FL (US)

(21) Appl. No.: 17/576,378

(22) Filed: Jan. 14, 2022

Related U.S. Application Data
(60) Provisional application No. 63/137,401, filed on Jan. 14, 2021.

(51) Int. Cl. H02J 50/00; H02J 50/40; H02J 50/10

(52) U.S. Cl. CPC H02J 50/005; H02J 50/10; H02J 50/402

(57) ABSTRACT

A contactless charging system for smart garments having coils whose centroids are not colinear. Folding a coil in half through its centroid will null out its inductance. A smart garment having 3 coils that have centroids that are not colinear is proposed. Accordingly, there is no single folding line that intersects all 3 centroids thereby nullifying inductance. Power can be combined with one or more rectifiers such that power is not cancelled. The present disclosure is suitable for any charging environment or apparatus, such as, drawer or hanger.

### CROSS-REFERENCE TO RELATED APPLICATIONS

This application is related to and claims the benefit of priority under 35 U.S.C. § 119(e) to U.S. Provisional Patent Application No. 63/137,401 entitled, “WIRELESS CHARGING SYSTEM FOR SMART GARMENTS SUPPORTING MULTIPLE CHARGING METHODS” filed on Jan. 14, 2021 and related to U.S. Provisional Patent Applications Nos. 63/128,474 entitled, “CONTACTLESS CHARGING DRAWER FOR SMART GARMENTS” filed on Dec. 21, 2020, No. 62/519,099 entitled, “SYSTEM AND METHOD FOR WIRELESS CHARGING OF SMART GARMENTS” filed on Jun. 13, 2017 and related to U.S. patent application Ser. No. 16/005,579 entitled, “SYSTEM AND METHOD FOR WIRELESS CHARGING OF SMART GARMENTS” filed on Jun. 11, 2018, all of which are hereby incorporated by reference in their entirety.

### FELD OF THE DISCLOSURE

The present disclosure relates to techniques for wireless charging of smart textiles, such as smart garments. More specifically, this disclosure describes apparatuses and systems for robust charging of smart garments in multiple charging platforms.

### BACKGROUND

Smart clothing is an emerging market with tremendous growth potential. Among the proposed functions that could be integrated into clothing are vital sign monitoring, user interfaces, active heating and cooling, active comfort control, active displays, gesture recognition, posture monitoring and/or hazardous condition monitoring. Such functions generally require a power source, however.

Often, these devices include battery packs that last typically from a few hours to a couple of days. The constant use of these devices may require periodical charging. In some cases, such an activity may be tedious and may represent a burden to users. For example, a user may be required to carry chargers or additional batteries and may have to remember to plug in the device or the batteries for a suitable amount of time. In addition, users have to find available power sources to connect to. In many occasions, such an activity may render the clothing inoperable during charging. Wearable devices are designed, fabricated, and assembled with disparate shapes, sizes, and structures by a variety of suppliers. They are often operated with DC power from a battery. However, the battery is often small, compact, and light in weight so as to accommodate constraints of the wearable devices. Thus, the battery needs to be recharged after a period of use.

The recharger for the battery is usually customized for the particular wearable device. As a result, a user has to purchase multiple rechargers. In one instance, the user must carry around the appropriate recharger for use as needed with each wearable device as the battery becomes completely depleted.

Items of clothing are increasingly being provided with sensors, particularly in the area of sports, but also in the stationary or ambulatory monitoring of patients and workers. These sensors can measure physiological data of a wearer of such an item of clothing. For example, physiological data may include heart rate, electrocardiogram (ECG) signals, respiratory signals, current state of motion, body temperature, and many other types of data.

For example, heart rate can be measured through two electrodes that make contact with the skin of a human. The human heartbeat, in particular its so-called RR-Interval, brings about voltage changes on the skin, which can be measured by the two electrodes.

The measurement of respiration may take place through meander-shaped electrical conductors, which can be arranged in the chest and/or abdomen region and respectively represent an electrical coil and are connected to an electrical oscillator. Due to respiratory motion, the circumference of the chest and abdomen change, along the length of the conductors, the inductance of the coils, and finally the oscillation frequency. The alteration of the oscillation frequency can be evaluated and permits conclusions to be made with regard to the respiratory motion.

The state of motion of a human can be detected by way of position sensors or acceleration sensors. Position sensors are able to provide data with respect to their position in space, while acceleration sensors measure acceleration acting upon them. The sensors can be arranged at individual body parts such as the limbs for instance, in order to measure the motion and/or position of the body parts. Distance sensors can be used in order to measure the distance between individual body parts in relation to one another.

In addition to the advent of smart garments, the proliferation of handheld devices, mobile telephones, smart phones, electronic notepads, tablets, netbooks, e-readers, electronic personal music players and the like, the organization and charging of these devices have become an important concern for many consumers. Many Americans have multiple devices that need to be charged, re-charged, or synchronized at various periods of time or intermittently. These devices take up valuable space in an ever shrinking home or workspace.

Drawers and shelves can store, organize, secure and keep safe such devices. Recently, drawers, shelves and chests of drawers have been proposed for the charging of smart garments. Similarly, hanger-based charging systems have been introduced to charge the garment while hanging. These systems suffer from the same disadvantage. That is, the smart garment may not charge during certain conditions, such as, a particular fold.

There is a demonstrated need in the art for a wireless charging system applicable to multiple platforms is robust enough to charge regardless of the garments condition, fold, or orientation. The inventors of the present disclosure have contemplated this need and posited a garment based solution.

This overview is intended to provide an overview of subject matter of the present patent application. It is not intended to provide an exclusive or exhaustive explanation of the disclosure. Further limitations and disadvantages of conventional and traditional approaches will become apparent to one of skill in the art, through comparison of such systems with some aspects of the present disclosure as set forth in the remainder of the present application with reference to the drawings.

### SUMMARY OF THE DISCLOSURE

Techniques for wirelessly charging smart textiles, such as smart garments, are provided. Aspects of the present application provide a smart garment device with an array of integrated coils and rectifiers that enable wireless charging of the device from a drawer or hanger that produce a roughly uniform AC magnetic field. The smart garment can draw power from the magnetic field once placed within the enclosure, regardless of how the garment is placed in the enclosure. The method can be applied to garments of any shape, and multiple garments can be charged simultaneously by placing the multiple garments into the same magnetic field.

A contactless charging system for smart garments having coils whose centroids are not colinear is posited. Folding a coil in half through its centroid will null out its inductance. A smart garment having 3 coils that have centroids that are not colinear is proposed. Accordingly, there is no single folding line that intersects all 3 centroids thereby nullifying inductance. Power can be combined with one or more rectifiers such that power is not cancelled. The present disclosure is suitable for any charging environment or apparatus, such as, drawer or hanger.

According to some aspects, a wirelessly chargeable smart garment is provided comprising at least one textile, and a wireless power receiver integrated into the at least one textile, the wireless power receiver comprising a plurality of inductors, and a plurality of rectifying elements in series with respective inductors of the plurality of inductors.

According to some aspects, a system for wirelessly charging smart garments is provided, the system comprising an enclosure comprising at least one magnetic field source operable to produce an AC magnetic field within the enclosure, and a garment within the enclosure, the garment comprising at least one textile, and a wireless power receiver integrated into the at least one textile, the wireless power receiver comprising a plurality of inductors, and a plurality of rectifying elements in series with respective inductors of the plurality of inductors.

According to some aspects, a wirelessly chargeable smart garment is provided comprising at least one textile, and a wireless power receiver integrated into the at least one textile, the wireless power receiver comprising a plurality of interconnected unit cells, each unit cell of the plurality of unit cells comprising at least one inductor and at least one rectifying element.

According to some aspects, 3 receiver coils are configured such that their centroids not collinear.

According to some aspects, the 3 coils have different sizes.

According to some aspects, the shape of the coils is substantially circular spiral.

According to some aspects, the shape of the coils is substantially square spiral.

According to some aspects, the shape of the coils is substantially rectangular spiral.

According to some aspects, the shape of the coils is substantially parallelepiped spiral.

According to some aspects, there are 4 or more coils in a configuration which their centroids are not colinear.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

The drawings show exemplary smart garment charging configurations. Variations of these circuits, for example, changing the positions of, adding, or removing certain elements from the circuits are not beyond the scope of the present disclosure. The illustrate configurations, and complementary devices are intended to be complementary to the support found in the detailed description.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Similarly, for the purposes of clarity and brevity, not every component may be labeled in every drawing.

For a fuller understanding of the nature and advantages of the present invention, reference is made to the following detailed description of preferred embodiments and in connection with the accompanying drawings, in which:

FIG. 1 depicts an illustrative smart garment comprising a wireless charging circuit, according to some embodiments;

FIG. 2 depicts an illustrative wireless charging circuit in which groups of inductors and rectifiers are connected in parallel, according to some embodiments;

FIG. 3 depicts an array of inductors and rectifiers in a wireless charging circuit, according to some embodiments;

FIG. 4 illustrates a roll of fabric that contains a wireless charging circuit, according to some embodiments;

FIG. 5 depicts an array of unit cells of a wireless charging circuit, according to some embodiments;

FIG. 6 depicts a cross-sectional view of smart garments situated within a magnetic field generated by a coil, according to some embodiments;

FIG. 7 depicts a hanger charging apparatus for smart garments, according to some embodiments;

FIG. 8 depicts an exemplary receiver coil and charging circuitry, according to some embodiments;

FIG. 9 illustrate an exemplary single receiver coil and charging circuitry and shortcoming thereof, according to some embodiments;

FIG. 10 illustrates an exemplary two-coil receiver and charging circuitry and shortcoming thereof, according to some embodiments;

FIG. 11 illustrates an exemplary 3-coil receiver and charging circuitry, according to some embodiments;

FIG. 12 is a schematic of an exemplary 3-coil receiver and charging circuitry, according to some embodiments; and

FIGS. 13A-C depicts various implementations an exemplary 3-coil receiver and charging circuitry, according to some embodiments.

### DETAILED DESCRIPTION

The present disclosure relates to techniques for wireless charging of smart textiles, such as smart garments. More specifically, this disclosure describes apparatuses and systems for contactless charging of smart garments which have 3-planar wireless power receiver coils. The inventors of the present disclosure contemplate an arrangement of 3 planar wireless power receiver coils with centroids that are not co-linear with one another. No matter what direction the coil arrangement is folded (once), at least one coil will have mutual inductance to the charger to be able to receive power.

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure are set forth in the proceeding in view of the drawings where applicable.

Wearable technology is everywhere in modern life in the form of discrete devices such as smart watches, fitness bands and earbuds. Wearables monitor heart rate, blood oxygen level and movements, and serve as a user interface to cloud services through mobile phones. These functions are typically realized with standalone gadgets that must be charged separately on their own docking stations. Furthermore, data collection is limited to those areas on the body where it is convenient to attach a gadget-typically the wrist or the ear.

The integration of sensing devices into clothing promises better access to sensing at distributed locations around the body—for example, ECG and respiration could be measured on the chest while pulse rate is measured at the wrist. Some consumer products integrating electronics into clothing have been released. For example, Levi's and Google have released a smart jacket with which you can control your mobile phone while keeping your phone in the pocket.

With respect to wired charging, a wired connector may expose conductors that compromise the ability of the garment to withstand moisture during wear and washing. In addition, the user of the garment must manually connect the wired charger, making the overall maintenance of the garment more complicated and less convenient. With respect to wireless charging, the inventor has recognized that some potential constructions of wireless charging arrangement will require proper alignment of charging components within the garment with a source of wireless power. For instance, some wireless charging systems might include mounting structures onto or into which the garment must be installed and arranged correctly to effectuate a transfer of power to the garment (e.g., a charging hanger).

The inventors have recognized techniques for wireless charging of a smart garment that do not compromise waterproofing or require any additional day-to-day effort on the part of the user. In particular, the inventor has recognized wireless charging techniques that do not require the user to align the garment to the charger. Aspects of the present application provide a smart garment device with an array of integrated coils and rectifiers that enable wireless charging of the device from a drawer or other enclosure that produces a roughly uniform AC magnetic field.

The smart garment can draw power from the magnetic field once placed within the enclosure, regardless of how the garment is placed in the enclosure. In some embodiments, this result may be achieved via interconnected unit cells, all, or at least some of which, include an inductor and a rectifier, so that at least some of the inductors from amongst the unit cells will generate current from the AC magnetic field irrespective of the orientation of various parts of the garment. The method of drawing power can be applied to garments of any shape, and multiple garments can be charged simultaneously by placing the multiple garments into the same magnetic field.

When inductors are arranged in arbitrary positions and directions within a time-varying (AC) magnetic field, the inductors would be expected to generate current in a variety of different ways. In particular, some of the inductors may couple in-phase to the magnetic field, some may couple in anti-phase, and some may not couple at all. As a result, the net DC power of the inductors may be unpredictable and may not represent a net positive power.

In contrast, according to some embodiments of the present disclosure, a smart garment may include one or more inductors that are each arranged in series with one or more rectifiers (e.g., one or more diodes). When inductors are each arranged in series with one or more rectifiers, the rectifiers each produce a DC current from the AC current generated by the inductor. Then, when the DC currents output by the rectifiers are combined, the power received is combined in an additive fashion and a net DC power is produced.

Thus, even when the inductors are arranged in arbitrary positions and directions within an AC magnetic field, a net DC power may be produced. In some embodiments, a net DC power may be produced from inductors in a non-series arrangement with one or more rectifiers. For instance, an inductor may be connected to a full bridge rectifier (e.g., at opposing connections of the bridge) so that a net DC current is output from the bridge.

An object of the present disclosure is to provide an effortless user experience for recharging smart garments. State of the art smart garments are powered from disposable batteries or use detachable electronics that must be recharged on a dedicated, usually wired, charger. These approaches require the user to spend time and mental effort on recharging their clothes.

According to some embodiments, a magnetic field for charging a smart garment may be produced within an enclosure, such as a piece of furniture (e.g., a drawer) or built into part of a clothing storage area, such as a closet. Irrespective of the particular enclosure, the magnetic field may be generated by one or more coils that wrap around part of the structure of the enclosure, thereby producing the magnetic field in the interior of the enclosure.

When a smart garment comprising one or more inductors is placed within the enclosure, power may be transferred to the smart garment by the magnetic field inducing a current in the inductors. As discussed above, a net DC power may be produced in the smart garment by arranging a rectifier in series with each of the inductors so that power is always effectively transferred to the smart garment irrespective of the orientation of each of the inductors.

It may be noted that, in some embodiments, use of a rectifier in this manner may sacrifice a substantial fraction of the total available power (e.g., around half) to ensure that net DC power is produced to obtain the benefit of allowing arbitrary orientations of the garment. To the extent that this reduction in power is undesirable, however, additional inductors may be added to the garment to increase the amount of power generated within the garment. In some embodiments, however, such a reduction in available power may not occur—for instance, in some embodiments in which the rectifier is a full-bridge rectifier.

While the techniques described herein are primarily discussed in relation to garments, it will be appreciated that the techniques may be applied with respect to any textile, not just those that may be worn. For instance, upholstery (e.g., as part of furniture, within a vehicle, etc.) may incorporate smart electronics and a battery that may be charged via the techniques described herein.

According to some embodiments, inductors and rectifiers within a smart garment may be arranged into a repeating pattern or array. Forming a circuit within a textile by electrically connecting “unit cells” in parallel that each contain the same arrangement of inductors and rectifiers may have several advantages. First, the resulting circuit has redundancy in the event that one of the unit cells is damaged or otherwise fails to contribute power through induction.

Although a portion of the circuit may contain a damaged inductor and a portion of an open circuit, this may not negatively affect the performance of the remainder of the circuit. This feature also enables the textile to be cut and handled in a traditional manner. For instance, a roll of fabric may be produced that incorporates the circuit array throughout. This fabric may be cut and assembled into a garment in the traditional way, since cutting through a unit cell of the circuit array will not negatively affect the performance of the circuit portions that remain in the garment.

As used herein, the term “smart garment” refers to an article of clothing that incorporates one or more active electronic components, which draw power to operate. Such components may, for example, be configured for electronic sensing, computation, communications and/or actuation. A smart garment may additionally incorporate any number of passive electrical components, such as wires, resistors, capacitors, inductors, transformers, and/or diodes, etc.

Typically, in such products, the electronic components are encased in a plastic housing that is attached to the garment for use and detached for charging or when the garment is washed. Thus, additional user intervention is required to maintain the garment. To offer a more user-friendly smart garment, we need to seal the electronic device completely so that it can survive machine washing. This implies that a charging port is not allowed—there is a need in the art to charge wirelessly.

The critical problem with charging garments with flexible coils is that they may be folded. When hung on a hanger this is not the case, but garments are typically folded to be put in a drawer. If the fold intersects the midpoint of the coil, the coil inductance will approach zero and it will not be able to transfer wireless power. This invention provides a small array of 3 coils with centroids that are not co-linear. Folding along any line may intersect a maximum of 2 centroids, which ensures that at least one coil is available for charging. The power from the 3 coils is combined with rectifiers or diodes to ensure that cancellation of ac induced voltage does not occur.

Following below are more detailed descriptions of various concepts related to, and embodiments of, techniques for wireless charging of smart garments. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

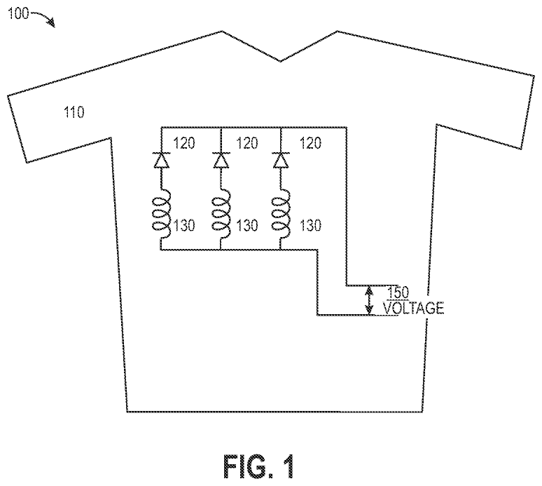

FIG. 1 depicts an illustrative smart garment comprising a wireless charging circuit, according to some embodiments. Smart garment 100 includes a textile 110 and a wireless charging circuit embedded within (or otherwise attached to) the textile that includes rectifiers (which may also be referred to as rectifying elements) 120 and inductors 130. Although three rectifiers and inductors are shown in the example of FIG. 1, it will be appreciated that in general any number of inductors serially coupled to respective rectifiers may be included in smart garment 100.

In the example of FIG. 1, the rectifiers 120 are connected serially to respective inductors 130, and the inductor-rectifier pairs are connected to one another in parallel. A net voltage 150 may be produced across this circuit when the smart garment 100 is placed within an AC magnetic field. The voltage 150 may be coupled to a battery and/or to other components of the smart garment 100.

The inductors 130 may be fabricated using any suitable method. For example, the inductors may be comprised of conductive fibers woven or knitted into the textile. Alternatively, the inductors may be fabricated using a planar or three-dimensional printing process and later integrated into the textile, or simply wound from electrical wire. According to some embodiments, the inductors 130 may include spiral conductive coils.

While in the example of FIG. 1 the rectifiers 120 are depicted as diodes, in general such rectifiers (or “rectifying elements”) may include other examples of voltage rectifiers, such as half-bridge rectifiers and/or full-bridge rectifiers, both passive and/or synchronous. Irrespective of the type of rectifier(s) included in smart garment 100, the rectifiers 120 may be, according to some embodiments, realized as fiber-based devices fully integrated into the textile, and/or realized as discrete solid-state devices attached to the textile.

According to some embodiments, rectifiers 120 may include one or more light-emitting diodes (LEDs). This approach may allow the garment to light up while simultaneously being charged, for instance to indicate charging is taking place and/or for aesthetic purposes. In some cases, the one or more LEDs may also be illuminated during wear for aesthetic effect.

According to some embodiments, rectifiers 120 may include one or more photovoltaic cells. During charging, a photovoltaic cell may function as a diode, whereas during wearing of the smart garment 100, the cell could generate power from solar energy.

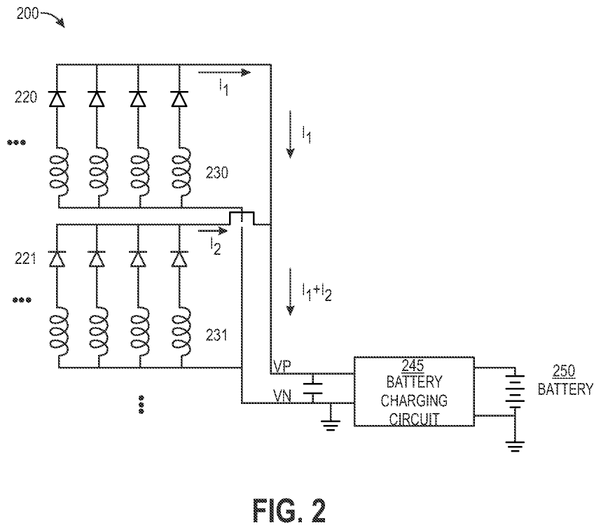

In general, any number of inductors 130 and rectifiers 120 may be connected together within one or more circuits of the smart garment 100. As discussed above, connecting rectifiers in serial with respective inductors ensures that no matter the relative orientation of the inductors with respect to a magnetic field, a net positive DC current is produced. Groups of inductors 130 and rectifiers 120 may be arranged in numerous arrangements, including by arranging groups of inductors and rectifiers in parallel with one another, such as is shown by the example of FIG. 2. In addition, any number of other components, including any number of batteries, may be connected to any number of wireless charging circuits.

The example of FIG. 2 depicts a wireless charging circuit 200 in which a first subcircuit comprising rectifiers 220 each connected serially to respective inductors 230, a second subcircuit comprising rectifiers 221 each connected serially to respective inductors 231, wherein the first and second subcircuits are connected to one another in parallel. In the example of FIG. 2, a net DC voltage V(VP, VN) produced by the inductors 230 and 231, and rectified by the rectifiers 220 and 221, charges battery 250 via the battery charging circuit 245.

In the example of FIG. 2, current produced from the inductors 230 is shown as current I1, and current produced from the inductors 231 is shown as current I2. These currents combine to supply a net current I1+I2 to the battery charging circuit 245 along the line labeled “VP.”

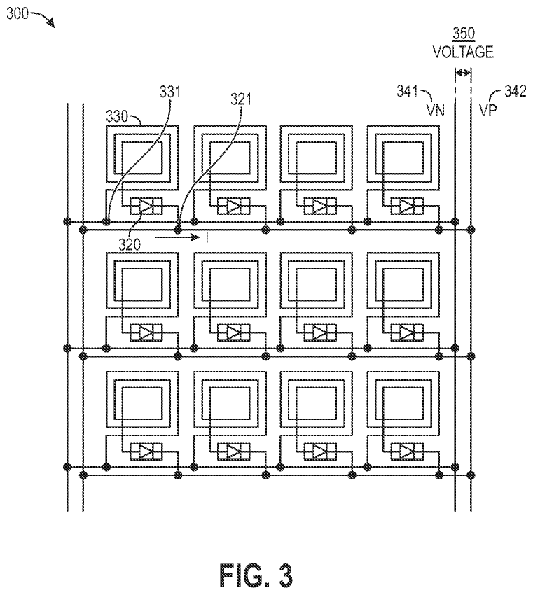

FIG. 3 depicts an array of inductors and rectifiers in a wireless charging circuit, according to some embodiments. In the example of FIG. 3, wireless charging circuit 300 includes twelve spiral coil inductors, of which inductor 330 is one example, each connected in serial to a respective rectifier, of which rectifier 320 is one example. Each inductor in a row of four inductors is connected to the other inductors in parallel, and each row of inductors is connected to the other rows of inductors in parallel. Inductors and rectifiers in FIG. 3 are connected to the voltage lines 341 (VN) and 342 (VP) via respective nodes; for instance, inductor 330 is connected to voltage line 341 via node 331, and rectifier 320 is connected to voltage line 342 via node 321. As a result of current being produced by the inductors and rectified, a net DC voltage 350 is produced by the inductors.

In the example of FIG. 3, the wireless charging circuit 300 has sufficient redundancy that if one or more of the inductors ceased to carry or produce a current, the wireless charging circuit as a whole would continue to function (albeit with a potentially reduced voltage output). As discussed above, this allows a textile comprising a wireless charging circuit such as circuit 300 to be handled in a conventional manner.

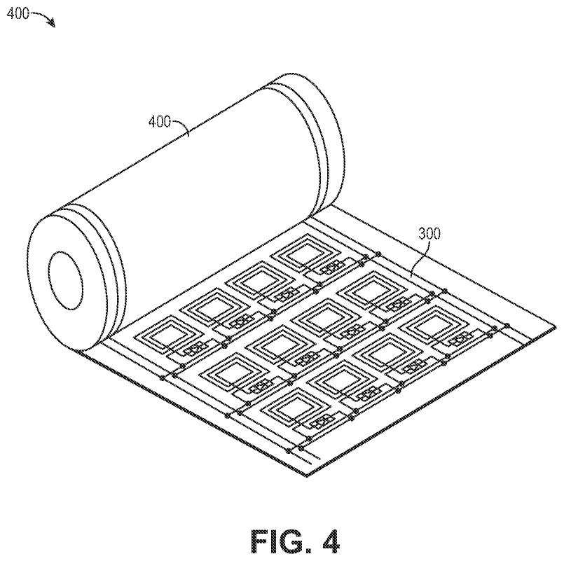

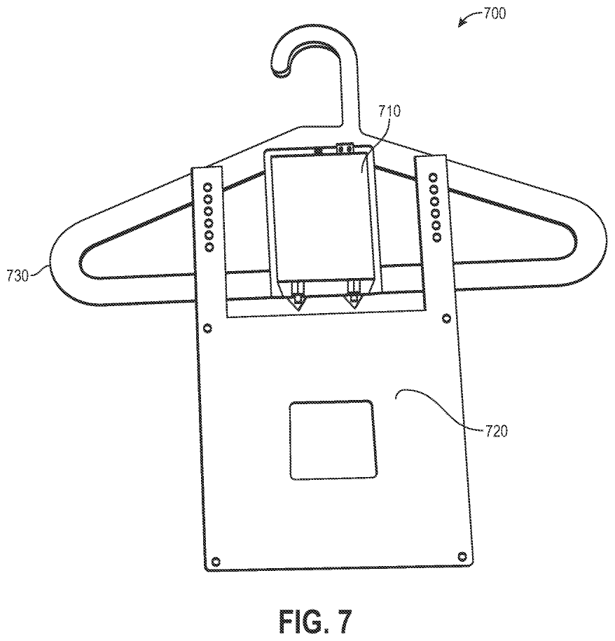

As one example, FIG. 4 illustrates a roll of fabric 400 that contains a wireless charging circuit, according to some embodiments. In the example of FIG. 4, wireless charging circuit 300 shown in FIG. 3 is incorporated into fabric 402. This fabric could, for instance, be rolled out and cut and handled in a manner conventional for producing garments or other textile-based items. It will be appreciated that fabric 400 may be utilized in numerous implementations that are not limited to charging by placing the fabric within an enclosure containing a magnetic field. For instance, fabric 400 may form part of a piece of furniture, such as a chair, and be charged via a technique other than the enclosure-based approach described below in relation to FIGS. 7A-7B.

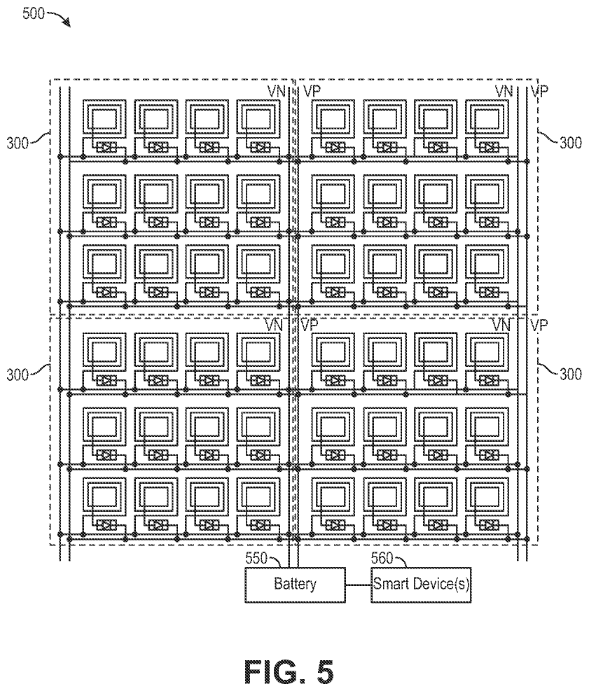

FIG. 5 depicts an array of unit cells of a wireless charging circuit, according to some embodiments. To illustrate an additional example of inductors and rectifiers arranged in repeating units, wireless charging circuit 500 includes four instances of wireless charging circuit 300 shown in FIG. 3 connected together in an array. Multiple voltage lines VN and VP are present within wireless charging circuit 500, which further allows the fabric to be cut in an arbitrary way without significantly inhibiting the circuit from generating a DC voltage that can be connected to battery 550. For example, if any of the four instances of wireless charging circuit 300 were cut in half in the example of FIG. 5 and the circuit placed in an AC magnetic field, the remaining three instances of wireless charging circuit 300 would continue to supply a voltage to battery 550 (and in some cases a portion of the cut instance of wireless charging circuit 300 may do so as well). Although not shown in FIG. 5 for clarity, current may flow from each of the rectifiers along the lines labeled VP to the battery 550.

In the example of FIG. 5, the battery 550 is connected to one or more smart devices 560. These devices may perform functions such as sensing, communications, computation and/or actuation within a garment in which wireless charging circuit 500 is provided. Such devices may include one or more sensors, processors, wireless devices (e.g., radio transmitter and/or receiver), actuators, computer readable media, or combinations thereof. In some embodiments, smart device(s) 560 may include one or more processors coupled to one or more computer readable media, the media storing instructions that, when executed by the one or more processors, perform a function within a garment in which wireless charging circuit 500 is provided.

For example, a garment configured to detect and provide feedback on bodily posture may include wireless charging circuit 500. In this example embodiment, the smart devices 560 may include a plurality of sensors to detect posture of a wearer of the garment coupled to one or more processors coupled to the sensors and arranged to receive signals from the sensors. The one or more processors may evaluate posture based on the received signals and produce a visual and/or audible indication of the quality of the posture based on said signals (e.g., via one or more LEDs or other lights of the smart garment). In such an embodiment, it will be appreciated that the one or more processors may execute these acts via hardware, software (e.g., by executing instructions stored on one or more computer readable media), or a combination of both.

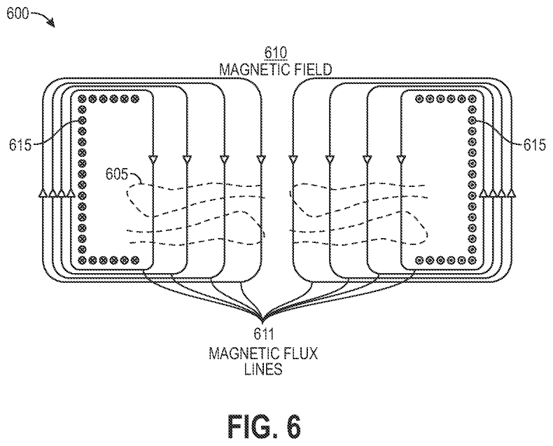

FIG. 6 depicts a cross-sectional view of smart garments situated within a magnetic field generated by a coil, according to some embodiments. In the example of FIG. 6, smart garments 605 are placed within a magnetic field 610. Smart garments 605 are shown in cross-section in the figure and represent folded items of clothing, such as a folded shirt, in cross-section. As illustrated, the smart garments 605 include a textile (shown in light gray) and a plurality of inductors (shown as black lines within the textile).

Magnetic field 610 may be produced by coil 615, shown in cross section protruding into and out of the plane of the drawing. According to some embodiments, coil 615 may produce a uniform, or substantially uniform, AC magnetic field. The magnetic field 610 is represented in the example of FIG. 6 by magnetic flux lines 611 which connect locations with equal magnetic flux.

According to some embodiments, the coil 615 may be incorporated into a housing or other enclosure surrounding at least part of the smart garments 605. For instance, the coil 615 may be incorporated into a washing machine or clothes dryer such that a magnetic field is generated within its interior, thereby allowing the wireless charging of smart garments placed within the machine or dryer. In some embodiments, the coil 615 may be integrated into a piece of furniture such as a chest of drawers, or built in to a clothes storage area.

According to some embodiments in which the coil 615 is incorporated into an enclosure, a back iron may be formed by encapsulating the enclosure with high-permeability material so as to contain most of the return flux inside the drawer housing. As such, the volume surrounding the enclosure can be largely free from electromagnetic interference. Examples of such high-permeability material may include ferrite and iron.

According to some embodiments in which the coil 615 is incorporated into an enclosure, the enclosure may comprise a mechanism that activates and deactivates wireless charging within by activating and deactivating current flowing through the coil 615. In some embodiments, such a mechanism may be a power button or other such device that a user may interact with to enable or disable charging. In some embodiments, such a mechanism may include an interlock mechanism that activates when the enclosure is closed (e.g., when a door or other feature a user may access to supply smart garments to the interior of the enclosure is closed). This approach may ensure that electromagnetic interference is contained. In some embodiments, charging may be activated or deactivated at certain times of day or night.

FIG. 7 depicts a hanger charging apparatus for smart garments, according to some embodiments. A transmitter coil is disposed on the hanger 730 (or attached thereto) itself. In some embodiments, the transmitter 710 or RF power source is also disposed on the hanger. In other embodiments, it can be remote and in electrical communication with the hanger. Transmitter coil 720 is encompassed by a 20 mm thick box so that the magnetic field outside the box is below ICNIRP regulation (12.5 A/m-general public, local exposure, 6 minutes).

A hanger charging system is well suited to 1-to-1 charging. That is, efficient charging of one hanger to one garment, as it offers good alignment if coils are well-positioned. The receiver coil can but shouldn't be folded in this scenario.

In some embodiments, the transmitter coil has non-uniform spacing which provides more uniform field distribution. In one or more embodiments, the operating frequency is 400 kHz. However, numerous bandwidths remain with scope of the present disclosure.

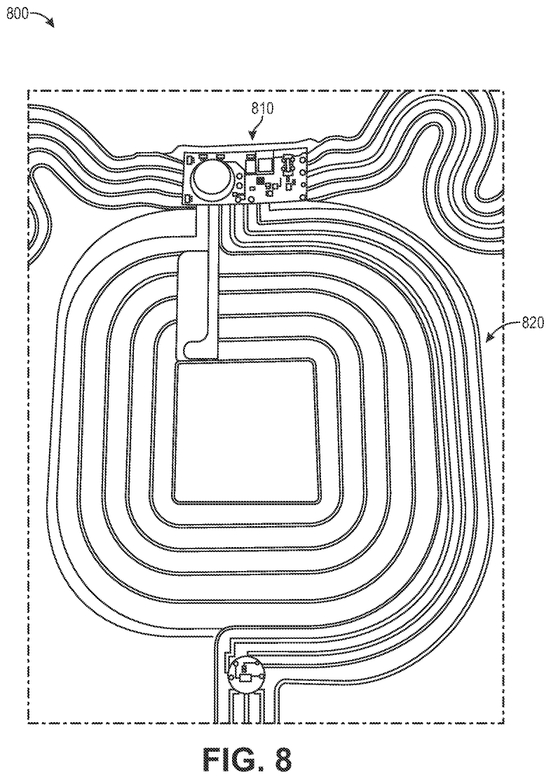

FIG. 8 depicts an exemplary receiver coil 820 and charging circuitry 810, according to some embodiments. The receiver coil is optimized for quality factor and coupling. A large Rx coil design charges well either on the hanger or in the drawer. The key exception is that, if folded in half and put in a drawer, mutual inductance goes to zero and it will not charge. This limitation only applies to wireless charging systems in which the receiver coils are flexible enough to be folded. Known prior art in wireless charging assumes a rigid receiver coil, thus this limitation is not addressed.

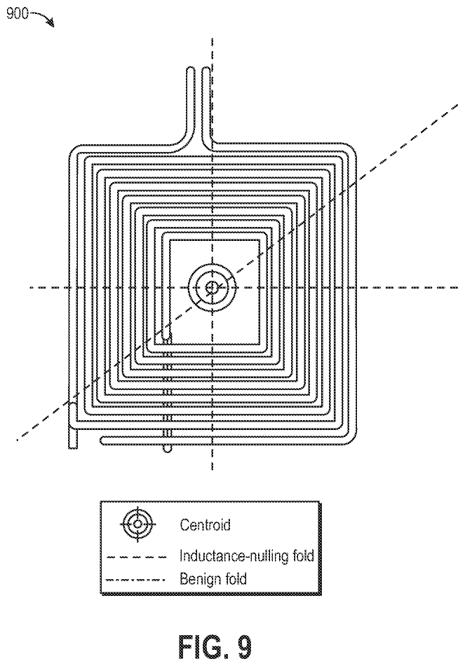

FIG. 9 illustrate an exemplary single receiver coil and charging circuitry 900 and shortcoming thereof, according to some embodiments. As can be appreciated by one skilled in the art, folding a coil in half through its centroid will null out its inductance. Any fold, inter alia, along the dashed lines in FIG. 9 will null out the inductance of the coil thereby preventing (or largely mitigating, in practice) the Rx coil's charging capacity.

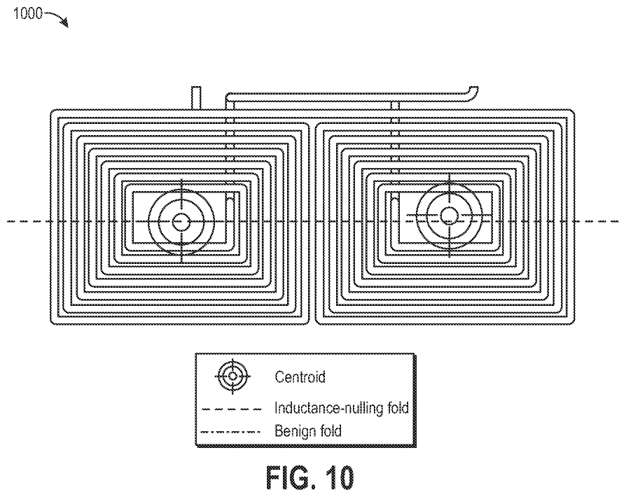

FIG. 10 illustrates an exemplary two-coil receiver and charging circuitry and shortcoming thereof, according to some embodiments. Similarly, even a two-coil system will not obviate this disabling threat. As can be appreciated, there is a folding line that intersects the centroids of any two coils in a plane. This fold would null out the inductance of both coils.

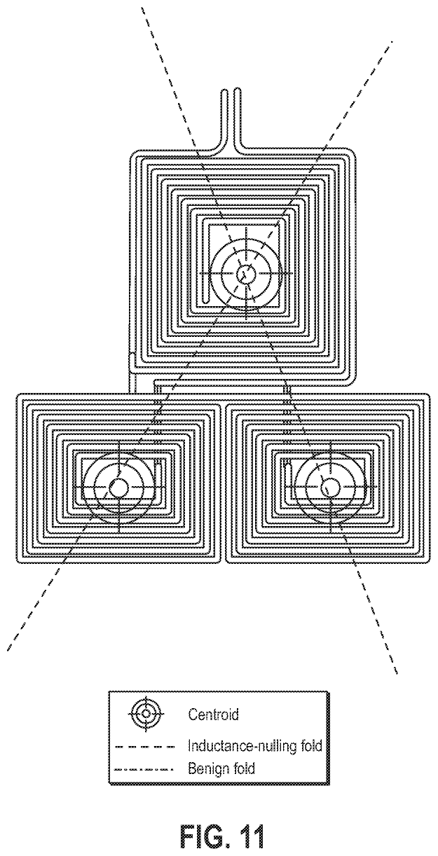

The inventors of the present disclosure propose a coil array structure that will charge in the drawer even if it is folded along any line. FIG. 11 illustrates an exemplary 3-coil receiver and charging circuitry, according to some embodiments. With 3 coils that have centroids that are not colinear, there is no single folding line that intersects all 3 centroids-thus a single fold will always leave one coil with inductance that can be used for charging. This is the first demonstration of shirt charging compatible with both common methods of clothing storage. This enables flexibility for customers.

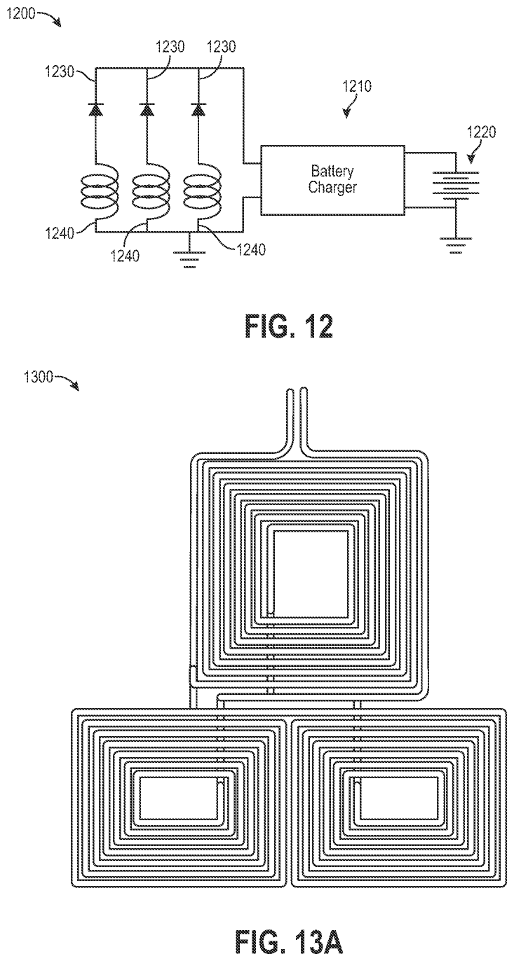

FIG. 12 is a schematic of an exemplary 3-coil receiver 1240 and charging circuitry 1200, according to some embodiments. The present embodiment combines power from each coil 1240 with a rectifier so that power does not cancel. In practice, this can be accomplished with diodes 1230 in series with each coil. The power becomes rectified and conditioned, e.g., low-pass filtered, at the battery charger 1210 and sent to the batter 1220.

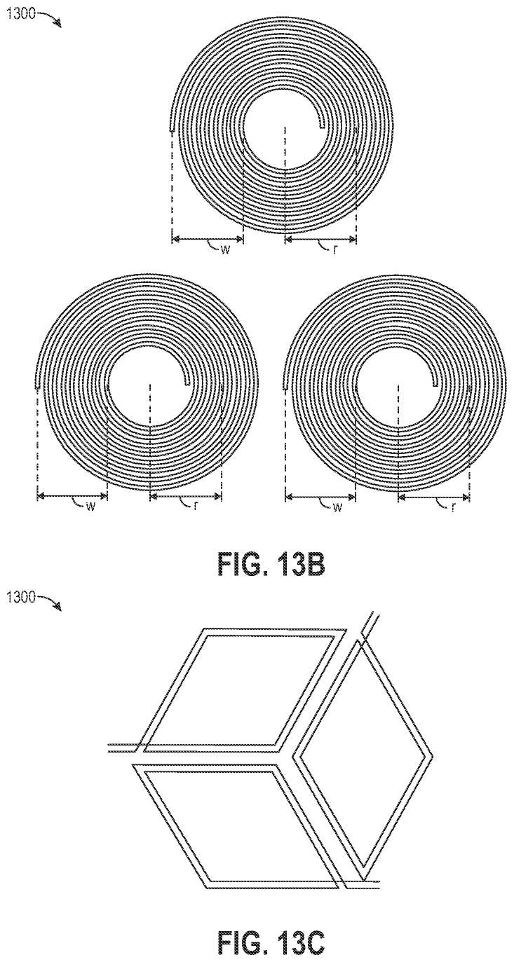

FIGS. 13A-C depicts various implementations an exemplary 3-coil receiver and charging circuitry, according to some embodiments. As can be appreciated, many coil shapes and configurations are possible and remain within the scope of the present disclosure. Furthermore, while numerous 3-coil designs are contemplated, any greater plurality is not beyond the scope of the invention.

In certain embodiments, an operating frequency centered around 400 kHz is used. But a wide range of operating frequencies are within scope of the present disclosure. One objective may desire a to operate at a frequency where power loss due to radiation is minimal. The relay coil is tuned to this operating frequency. The Tx coil can be tuned pretty close to this frequency but tuning slightly off-resonance may be desirable to optimize the circuit operation.

A preferred embodiment may come more into tune as more receivers are added into the field. The receiver coils are non-resonant in this example, in order to simplify the circuits needed in the garment.

In some embodiments, the fundamental frequency is used throughout the chamber (drawer, chest thereof, etc.). That is, the near field inductive charging frequency which the relay coil is tuned to. In other embodiments, harmonics are used. In particular, the relay coil could be tuned to a harmonic of the Tx coil. As one skilled in the art can appreciate, many combinations are possible-all within the scope of the present disclosure.

In yet other embodiments, resonant cavities are created by the use of reflective walls. For example, the optional back iron could be used to surround the drawer thereby creating a resonant drawer, the size of which would be tuned to the drawer. In some embodiments, a standing wave could be generated using the fundamental frequency of the drawer. In other embodiments, higher harmonics could be exploited.

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure are set forth in the proceeding in view of the drawings where applicable.

### Select Examples

Example 1 provides a contactless charging apparatus for smart garments disposed within a smart garment comprising 3 or more charging coils, each having centroid, wherein the centroids are not collinear with one another.

Example 2 provides a system according to anyone of the preceding or proceeding systems and/or methods further comprising a diode.

Example 3 provides a system according to anyone of the preceding or proceeding systems and/or methods further comprising a diode for each charging coil.

Example 4 provides a system according to anyone of the preceding or proceeding systems and/or methods further comprising a charging circuit.

Example 5 provides a system according to anyone of the preceding or proceeding systems and/or methods further comprising a battery.

Example 6 provides a system according to anyone of the preceding or proceeding systems and/or methods, wherein the smart garment is configured such that no fold of the smart garment will null out a collective inductance of the 3 or more charging coils.

Example 7 provides a contactless charging system including a smart garment comprising 3 or more charging coils, each having centroid, wherein the centroids are not collinear with one another, a transmitter coil, and a power source in electrical communication with the transmitter coil.

Example 8 provides a system according to anyone of the preceding or proceeding systems and/or methods further comprising a hanger.

Example 9 provides a system according to anyone of the preceding or proceeding systems and/or methods, wherein the transmitter coil is disposed on the hanger.

Example 10 provides a system according to anyone of the preceding or proceeding systems and/or methods, wherein the power supply is disposed on the hanger.

Example 11 provides a system according to anyone of the preceding or proceeding systems and/or methods, further comprising a drawer.

Example 12 provides a system according to anyone of the preceding or proceeding systems and/or methods, wherein the transmitter coil is disposed on the drawer.

Example 13 provides a system according to anyone of the preceding or proceeding systems and/or methods, wherein the power supply is disposed on the drawer.

Example 14 provides a system according to anyone of the preceding or proceeding systems and/or methods, wherein the smart garment further comprises a diode for each charging coil.

Example 15 provides a system according to anyone of the preceding or proceeding systems and/or methods, wherein the smart garment further comprises a charging circuit.

Example 16 provides a system according to anyone of the preceding or proceeding systems and/or methods, wherein the smart garment further comprises a battery.

Example 17 provides a system according to anyone of the preceding or proceeding systems and/or methods, wherein the smart garment is configured such that no fold of the smart garment will null out a collective inductance of the 3 or more coils.

Example 18 provides a method for contact charging smart garments comprising receiving electromagnetic energy at 3 or more charging coils, rectifying the electromagnetic energy, and charging a battery with the rectified electromagnetic energy, wherein the smart garment is configured such that no fold of the smart garment will null out a collective inductance of the 3 or more coils.

Example 19 provides a system according to anyone of the preceding or proceeding systems and/or methods, wherein the charging coils each have a centroid.

Example 20 provides a system according to anyone of the preceding or proceeding systems and/or methods, wherein the centroids are not collinear with one another.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein.

Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The foregoing outlines features of one or more embodiments of the subject matter disclosed herein. These embodiments are provided to enable a person having ordinary skill in the art (PHOSITA) to better understand various aspects of the present disclosure. Certain well-understood terms, as well as underlying technologies and/or standards may be referenced without being described in detail. It is anticipated that the PHOSITA will possess or have access to background knowledge or information in those technologies and standards sufficient to practice the teachings of the present disclosure.

The PHOSITA will appreciate that they may readily use the present disclosure as a basis for designing or modifying other processes, structures, or variations for carrying out the same purposes and/or achieving the same advantages of the embodiments introduced herein. The PHOSITA will also recognize that such equivalent constructions do not depart from the spirit and scope of the present disclosure, and that they may make various changes, substitutions, and alterations herein without departing from the spirit and scope of the present disclosure.

The above-described embodiments may be implemented in any of numerous ways. One or more aspects and embodiments of the present application involving the performance of processes or methods may utilize program instructions executable by a device (e.g., a computer, a processor, or other device) to perform, or control performance of, the processes or methods.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above.

The computer readable medium or media may be transportable, such that the program or programs stored thereon may be loaded onto one or more different computers or other processors to implement various ones of the aspects described above. In some embodiments, computer readable media may be non-transitory media.

Note that the activities discussed above with reference to the FIGURES which are applicable to any integrated circuit that involves signal processing (for example, gesture signal processing, video signal processing, audio signal processing, analog-to-digital conversion, digital-to-analog conversion), particularly those that can execute specialized software programs or algorithms, some of which may be associated with processing digitized real-time data.

In some cases, the teachings of the present disclosure may be encoded into one or more tangible, non-transitory computer-readable mediums having stored thereon executable instructions that, when executed, instruct a programmable device (such as a processor or DSP) to perform the methods or functions disclosed herein. In cases where the teachings herein are embodied at least partly in a hardware device (such as an ASIC, IP block, or SoC), a non-transitory medium could include a hardware device hardware-programmed with logic to perform the methods or functions disclosed herein. The teachings could also be practiced in the form of Register Transfer Level (RTL) or other hardware description language such as VHDL or Verilog, which can be used to program a fabrication process to produce the hardware elements disclosed.

In example implementations, at least some portions of the processing activities outlined herein may also be implemented in software. In some embodiments, one or more of these features may be implemented in hardware provided external to the elements of the disclosed figures, or consolidated in any appropriate manner to achieve the intended functionality. The various components may include software (or reciprocating software) that can coordinate in order to achieve the operations as outlined herein. In still other embodiments, these elements may include any suitable algorithms, hardware, software, components, modules, interfaces, or objects that facilitate the operations thereof.

Any suitably-configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, an FPGA, an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, processors may store information in any suitable type of non-transitory storage medium (for example, random access memory (RAM), read only memory (ROM), FPGA, EPROM, electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe.

Any of the memory items discussed herein should be construed as being encompassed within the broad term ‘memory.’ Similarly, any of the potential processing elements, modules, and machines described herein should be construed as being encompassed within the broad term ‘microprocessor’ or ‘processor.’ Furthermore, in various embodiments, the processors, memories, network cards, buses, storage devices, related peripherals, and other hardware elements described herein may be realized by a processor, memory, and other related devices configured by software or firmware to emulate or virtualize the functions of those hardware elements.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a personal digital assistant (PDA), a smart phone, a mobile phone, an iPad, or any other suitable portable or fixed electronic device.

Also, a computer may have one or more input and output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Computer-executable instructions may be in many forms, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various embodiments.

The terms “program” or “software” are used herein in a generic sense to refer to any type of computer code or set of computer-executable instructions that may be employed to program a computer or other processor to implement various aspects as described above. Additionally, it should be appreciated that according to one aspect, one or more computer programs that when executed perform methods of the present application need not reside on a single computer or processor, but may be distributed in a modular fashion among a number of different computers or processors to implement various aspects of the present application.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code may be executed on any suitable processor or collection of processors, whether provided in a single computer or distributed among multiple computers.

Computer program logic implementing all or part of the functionality described herein is embodied in various forms, including, but in no way limited to, a source code form, a computer executable form, a hardware description form, and various intermediate forms (for example, mask works, or forms generated by an assembler, compiler, linker, or locator). In an example, source code includes a series of computer program instructions implemented in various programming languages, such as an object code, an assembly language, or a high-level language such as OpenCL, RTL, Verilog, VHDL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In some embodiments, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc.

Other components such as external storage, additional sensors, controllers for audio/video display, and peripheral devices may be attached to the board as plug-in cards, via cables, or integrated into the board itself. In another example embodiment, the electrical circuits of the FIGURES may be implemented as standalone modules (e.g., a device with associated components and circuitry configured to perform a specific application or function) or implemented as plug-in modules into application-specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this disclosure.

In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

### Interpretation of Terms

All definitions, as defined and used herein, should be understood to control over dictionary definitions, definitions in documents incorporated by reference, and/or ordinary meanings of the defined terms. Unless the context clearly requires otherwise, throughout the description and the claims:

“comprise,” “comprising,” and the like are to be construed in an inclusive sense, as opposed to an exclusive or exhaustive sense; that is to say, in the sense of “including, but not limited to”.

“connected,” “coupled,” or any variant thereof, means any connection or coupling, either direct or indirect, between two or more elements; the coupling or connection between the elements can be physical, logical, or a combination thereof.

“herein,” “above,” “below,” and words of similar import, when used to describe this specification shall refer to this specification as a whole and not to any particular portions of this specification.

“or,” in reference to a list of two or more items, covers all of the following interpretations of the word: any of the items in the list, all of the items in the list, and any combination of the items in the list.

the singular forms “a”, “an” and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined.

Elements other than those specifically identified by the “and/or” clause may optionally be present, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, the term “between” is to be inclusive unless indicated otherwise. For example, “between A and B” includes A and B unless indicated otherwise.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke 35 U.S.C. § 112(f) as it exists on the date of the filing hereof unless the words “means for” or “steps for” are specifically used in the particular claims; and (b) does not intend, by any statement in the disclosure, to limit this disclosure in any way that is not otherwise reflected in the appended claims.

The present invention should therefore not be considered limited to the particular embodiments described above. Various modifications, equivalent processes, as well as numerous structures to which the present invention may be applicable, will be readily apparent to those skilled in the art to which the present invention is directed upon review of the present disclosure.

What is claimed is:

1. A contactless charging apparatus for smart garments disposed within a smart garment comprising:
3 or more charging coils, each having centroid;
wherein the centroids are not collinear with one another.

2. A contactless charging apparatus according to claim 1, further comprising a diode.

3. The contactless charging apparatus according to claim 2, further comprising a diode for each charging coil.

4. The contactless charging apparatus according to claim 1, further comprising a charging circuit.

5. The contactless charging apparatus according to claim 1, further comprising a battery.

6. The contactless charging apparatus according to claim 1, wherein the smart garment is configured such that no fold of the smart garment will null out a collective inductance of the 3 or more charging coils.

7. A contactless charging system:
a smart garment comprising:
3 or more charging coils, each having centroid;
wherein the centroids are not collinear with one another;
a transmitter coil; and
a power source in electrical communication with the transmitter coil.

8. The contactless charging system according to claim 7 further comprising a hanger.

9. The contactless charging system according to claim 8, wherein the transmitter coil is disposed on the hanger.

10. The contactless charging system according to claim 8, wherein the power supply is disposed on the hanger.

11. The contactless charging system according to claim 7 further comprising a drawer.

12. The contactless charging system according to claim 8, wherein the transmitter coil is disposed on the drawer.

13. The contactless charging system according to claim 8, wherein the power supply is disposed on the drawer.

14. The contactless charging system according to claim 7, wherein the smart garment further comprises a diode for each charging coil.

15. The contactless charging system according to claim 7, wherein the smart garment further comprises a charging circuit.

16. The contactless charging system according to claim 7, wherein the smart garment further comprises a battery.

17. The contactless charging system according to claim 7, wherein the smart garment is configured such that no fold of the smart garment will null out a collective inductance of the 3 or more coils.

18. A method for contact charging smart garments comprising:
receiving electromagnetic energy at 3 or more charging coils;
rectifying the electromagnetic energy; and
charging a battery with the rectified electromagnetic energy;
wherein the smart garment is configured such that no fold of the smart garment will null out a collective inductance of the 3 or more coils.

19. The method for contact charging smart garments according to claim 18, wherein the charging coils each have a centroid.

20. The method for contact charging smart garments according to claim 19, wherein the centroids are not collinear with one another.
